(19) United States
(12) Patent Application Publication
(10) Pub. No.: US 2025/0002712 A1
(43) Pub. Date: Jan. 2, 2025

(54) Molding Material

(71) Applicant: SEIKO EPSON CORPORATION, Tokyo (JP)

(72) Inventors: Tomohiro FUJITA, Matsumoto (JP); Takashi HIRAIWA, Fujimi (JP); Chieko NAKAJIMA, Suwa (JP); Kiyoaki SAKAGUCHI, Suwa (JP)

(21) Appl. No.: 18/756,155

(22) Filed: Jun. 27, 2024

(30) Foreign Application Priority Data
Jun. 29, 2023 (JP) 2023-107012

(51) Int. Cl. C08L 67/04; C08L 1/02

(52) U.S. Cl. CPC C08L 67/04; C08L 1/02; C08L 2205/025; C08L 2205/03; C08L 2205/16; C08L 2312/00

(57) ABSTRACT

A molding material according to one embodiment of the present disclosure contains cellulose fibers and a resin, and the resin includes a polyester-based elastomer and a highly polar polyester. In a molecular weight distribution curve by a GPC method, the resin has a maximum value 2 at a weight average molecular weight of 100,000 or more and a maximum value 1 at a weight average molecular weight less than that at the maximum value 2, and an area value in the maximum value 2 is smaller than an area value in the maximum value 1.

The present application is based on, and claims priority from JP Application Serial Number 2023-107012, filed Jun. 29, 2023, the disclosure of which is hereby incorporated by reference herein in its entirety.

### BACKGROUND

### 1. Technical Field

The present disclosure relates to a molding material.

### 2. Related Art

Heretofore, a molding material containing cellulose fibers, a resin, and the like has been known. For example, JP-A-2020-033541 has disclosed a cellulose composite resin containing cellulose fibers, a primary resin such as an olefin-based resin, and a rubber-containing polymer. The rubber-containing polymer described above is formed from an aliphatic or an aromatic hydrocarbon having only a specific functional group.

However, in the case of a composite material formed according to a related technique, if a molding thermal history exists in a manner such that, for example, molded products and/or gate materials formed during molding are melted, pelletized, and again molded, a mechanical strength of the composite material may be degraded in some cases.

### SUMMARY

According to an aspect of the present disclosure, there is provided a molding material comprising cellulose fibers and a resin, and the resin includes a polyester-based elastomer and a highly polar polyester. In a molecular weight distribution curve by a GPC method, the resin described above has a maximum value 2 at a weight average molecular weight of 100,000 or more and a maximum value 1 at a weight average molecular weight less than that at the maximum value 2, and an area value in the maximum value 2 is smaller than an area value in the maximum value 1.

### BRIEF DESCRIPTION OF THE DRAWINGS

FIG. 1 is Table 1 showing compositions of raw materials, molding methods, and evaluation results of molded products relating to molding materials of Examples.

FIG. 2 is Table 2 showing compositions of raw materials, molding methods, and evaluation results of molded products relating to molding materials of Examples and Comparative Examples.

FIG. 3 is Table 3 showing compositions of raw materials, molding methods, and evaluation results of molded products relating to molding materials of Comparative Examples.

### DESCRIPTION OF EMBODIMENTS

Hereinafter, embodiments of the present disclosure will be described. The following embodiments are to explain examples of the present disclosure. The present disclosure is not limited at all to the following embodiments and includes variously changed and/or modified embodiments to be performed without departing from the scope of the present disclosure. In addition, all the constituents to be described below are not always required to be essential constituents of the present disclosure.

### 1. MOLDING MATERIAL

A molding material according to one embodiment of the present disclosure is a molding material which contains cellulose fibers and a resin, and the resin includes a polyester-based elastomer and a highly polar polyester. In a molecular weight distribution curve by a GPC method, the resin described above has a maximum value 2 at a weight average molecular weight of 100,000 or more and a maximum value 1 at a weight average molecular weight less than that at the maximum value 2, and an area value in the maximum value 2 is smaller than an area value in the maximum value 1.

If a molding thermal history exists in a manner such that, for example, molded products and/or gate materials formed during molding are melted, pelletized, and again molded, various characteristics of the resin contained in the molding material are liable to be degraded due to the pyrolysis thereof. In particular, a low-temperature melting resin to be melted at less than 200° C. is liable to be pyrolyzed.

Accordingly, through intensive research carried out by the present inventors, it was found that when the resin appropriately contains high molecular weight components, even if the molding thermal history exists, a mechanical strength, such as Charpy impact strength and/or flexural elastic modulus, is superior.

To the molding material, known molding methods, such as injection molding and press working, may be applied. Molded products formed from the molding material are preferably used, as alternative to polystyrene and the like, for various types of containers, sheets, and housings for office supplies, such as printers, and home appliances.

Hereinafter, various types of raw materials included in the molding material will be described.

### 1.1. CELLULOSE FIBERS

The molding material according to this embodiment contains cellulose fibers. The cellulose fibers function as fillers in a molded product and contribute to an increase in volume of the molding material and/or an improvement in physical properties, such as strengths, of the molded product.

The cellulose fibers are derived from plants and are relatively abundant natural materials. Hence, when the cellulose fibers are used, compared to the case in which synthetic fibers are used, reduction in environmental loads can be promoted. The cellulose fibers are also advantageous in terms of procurement and cost of raw materials. In addition, among various types of fibers, the cellulose fibers have a high theoretical strength and also contribute to an improvement in strength of the molded product. As the cellulose fibers, besides the use of virgin pulp, waste paper, waste cloths, and the like may also be recycled. In addition, as the cellulose fibers, commercial products may also be used.

Although being primarily formed from cellulose, the cellulose fibers may also contain components other than the cellulose. As the components other than the cellulose, for example, hemicellulose and/or lignin may be mentioned. In addition, the cellulose fibers may be processed by bleaching or the like.

In order to improve the appearance of surfaces of molded products, the cellulose fibers have an average fiber length of preferably less than 500 μm and more preferably less than 50 μm. The average fiber length of the cellulose fibers can be obtained by a method performed in accordance with ISO 16065-2:2007.

The cellulose fibers are present, with respect to a total mass of the molding material, at a content of preferably 9 percent by mass or more, more preferably 18 percent by mass or more, even more preferably 27 percent by mass or more, further preferably 36 percent by mass or more, and even further preferably 45 percent by mass or more. In addition, the cellulose fibers are present, with respect to the total mass of the molding material, at a content of preferably 90 percent by mass or less, more preferably 80 percent by mass or less, and further preferably 70 percent by mass or less. When the content of the cellulose fibers is in the range described above, even if the molding thermal history exists, a preferable mechanical strength tends to be obtained.

### 1.2. RESIN

The molding material according to this embodiment contains a resin, and the resin includes a polyester-based elastomer and a highly polar polyester.

The polyester-based elastomer has a function as a resin base material and secures impact resistance (toughness) of the molded product. However, the polyester-based elastomer has a low compatibility with the cellulose fibers and is liable to cause interfacial peeling therefrom. Hence, since the highly polar polyester is used so as to function as a compatibilizer between the cellulose fibers and the polyester-based elastomer, the interface peeling can be suppressed.

The resin is preferably present at a content equal to or less than that of the cellulose fibers described above. In this case, even if the molding thermal history exists, a more preferable mechanical strength tends to be obtained.

### 1.2.1. POLYESTER-BASED ELASTOMER

The polyester-based elastomer has plasticity, and when the molded product is manufactured from the molding material, the polyester-based elastomer is melted to bind the cellulose fibers to each other. In addition, the polyester-based elastomer is responsible together with the cellulose fibers for the physical properties of the molded product. In particular, by the polyester-based elastomer, the toughness of the molded product is increased, and the impact strength is improved. Furthermore, the polyester-based elastomer has probability of being produced and used as bioplastics in the future and is also a material expected to facilitate the reduction in environmental loads.

As raw material monomers, the polyester-based elastomer preferably includes an alkylene diol which has an alkylene group with 2 to 8 carbon atoms and one of phthalic acid and an alkylene dicarboxylic acid which has an alkylene group with 2 to 8 carbon atoms. When the polyester-based elastomer includes the raw material monomers described above, even if the molding thermal history exists, a more preferable mechanical strength tends to be obtained.

The polyester-based elastomer is preferably formed by copolymerization between the above two types of raw material monomers. In addition, the copolymerization is performed by a known synthetic method.

As the alkylene dicarboxylic acid described above, for example, there may be mentioned a linear saturated aliphatic dicarboxylic acid, such as succinic acid, glutaric acid, adipic acid, pimelic acid, suberic acid, azelaic acid, or sebacic acid. Those alkylene dicarboxylic acids each may have a substituent in its molecular structure. For the synthesis of the polyester-based elastomer, at least one of those mentioned above is preferably used.

The phthalic acid may have a substituent in its molecular structure.

As the alkylene diol described above, for example, there may be mentioned a divalent alcohol, such as 1,2-ethanediol, 1,3-propanediol, 1,4-butanediol, 1,5-pentanediol, 1,6-hexanediol, 1,7-heptanediol, or 1,8-octanediol. For the synthesis of the polyester-based elastomer, at least one of those mentioned above is preferably used. The three types of raw material monomers described above are relatively easily available and may also be used for industrial and commercial purposes.

Besides the raw material monomers described above, the polyester-based elastomer may also include another raw material monomer. As the another raw material monomer, for example, there may be mentioned styrene, butadiene, acrylic acid, an acrylate ester, methacrylic acid, a methacrylate ester, acetonitrile, isobutylene, isoprene, or ethylene, and at least one of those mentioned above is preferably used. When the another raw material monomer as described above is included, even if the molding thermal history exists, a more preferable mechanical strength tends to be obtained.

When the another raw material monomer is incorporated in the polyester-based elastomer, the number of total moles of the another raw material monomer is preferably set to 1% to less than 50% with respect to the number of total moles of the raw material monomers. Accordingly, even if the molding thermal history exists, a more preferable mechanical strength tends to be obtained.

As the polyester-based elastomer, a commercial product may also be used. As the commercial product, for example, ES-A60NX, E-D27N, E-D42N, or ES Series (trade name, manufactured by Aronkasei Co., Ltd.) may be mentioned. As the polyester-based elastomer, at least one of those mentioned above may be used.

In addition, in the form of the molding material or the molded product, the presence or not of the polyester-based elastomer can be determined by the following physical property analysis and component analysis.

First, by the physical property analysis, the presence or not of a component having a composite elastic modulus of 100 MPa or less is confirmed. When the component described above is contained, the presence of the elastomer component is determined. In particular, for example, using a scan type probe microscope NX20 available from Park Systems Japan, a cross-section of the molding material or the molded product is measured in a contact mode. Accordingly, the presence or not of the component having a composite elastic modulus of 100 MPa or less can be confirmed. In addition, the presence or not of the elastomer component may also be confirmed using a known nano indenter.

Next, by a qualitative analysis using a pyrolysis gas chromatograph-mass spectrometry (GC-MS) method together with a Fourier transform infrared spectroscopy (FT-IR) method, whether or not the elastomer component is the polyester-based elastomer is determined. The pyrolysis GC-MS method is an analytical method to identify the fragments generated by the pyrolysis of the sample. The FT-IR method is an analytical method to identify the molecular structure of the sample from an infrared absorption spectrum of the sample. By those analytical methods, the molecular structure of the sample can be identified.

For the pyrolysis GC-MS method, for example, a GC/MS 5975 (manufactured by Agilent Technologies) provided with a Multi-Shot Pyrolyzer EGA/PY-3030D (manufactured by Frontier Laboratories Ltd.) is used. For the FT-IR method, for example, a Nicolet (registered trademark) 380 Continu μm (registered trademark) manufactured by Thermo Fisher Scientific is used.

The polyester-based elastomer is present, with respect to the total mass of the molding material, at a content of preferably 1 percent by mass or more, more preferably 5 percent by mass or more, and further preferably 10 percent by mass or more. In addition, the polyester-based elastomer is present, with respect to the total mass of the molding material, at a content of preferably 50 percent by mass or less, more preferably 40 percent by mass or less, and further preferably 30 percent by mass or less. When the content of the polyester-based elastomer is in the range described above, even if the molding thermal history exists, a more preferable mechanical strength tends to be obtained.

In addition, the content of the polyester-based elastomer is, with respect to a content of the highly polar polyester which will be described later, preferably 25 percent by mass or more (more preferably 50 percent by mass or more, further preferably 75 percent by mass or more, and particularly preferably 100 percent by mass or more), and a total content of the polyester-based elastomer and the highly polar polyester is preferably equal to or more than the content of the cellulose fibers described above. In the case as described above, even if the molding thermal history exists, a more preferable mechanical strength tends to be obtained.

In addition, the content of the polyester-based elastomer with respect to the content of the highly polar polyester which will be described later is preferably 400 percent by mass or less, more preferably 300 percent by mass or less, even more preferably 250 percent by mass or less, and further preferably 200 percent by mass or less. In the case as described above, even if the molding thermal history exists, a more preferable mechanical strength tends to be obtained.

### 1.2.2. HIGHLY POLAR POLYESTER

The highly polar polyester improves the compatibility between the cellulose fibers and the polyester-based elastomer. Accordingly, wettability of the polyester-based elastomer to the cellulose fibers is enhanced, and the flexural strength of the molded product is primarily improved.

The highly polar polyester has a relatively highly polar molecular structure, and in a repeating structure derived from a raw material monomer, the number of oxygen atoms is preferably one or more with respect to two carbon atoms. In the case as described above, even if the molding thermal history exists, a more preferable mechanical strength tends to be obtained. In particular, the highly polar polyester preferably includes, as the raw material monomer, lactic acid, hydroxybutyric acid, oxysuccinic acid, citric acid, malonic acid, succinic acid, serine, threonine, acrylic acid, methyl acrylate, and/or vinyl acetate. Those mentioned above are relatively easily available and may also be used for industrial and commercial purposes.

In particular, the highly polar polyester preferably includes at least one selected from the group consisting of a poly (lactic acid), a poly (hydroxybutyric acid), a poly (acrylic acid), a poly (methyl acrylate), and a poly (vinyl acetate). In addition, the highly polar polyester may be a copolymer, such as a polyethylene succinic acid or P3HBH (3-hydroxy (butyrate-co-hexanoate). Among those mentioned above, the highly polar polyester preferably includes at least one selected from the group consisting of a poly (lactic acid) and a poly (hydroxybutyric acid). Since having biodegradability, those compounds are able to reduce environmental loads, and even if the molding thermal history exists, a more preferable mechanical strength tends to be obtained . . . In addition, as the highly polar polyester, a commercial product may also be used.

The highly polar polyester is present, with respect to the total mass of the molding material, at a content of preferably 1 percent by mass or more, more preferably 5 percent by mass or more, even more preferably 10 percent by mass or more, further preferably 15 percent by mass or more, and particularly preferably 20 percent by mass or more. In addition, the highly polar polyester is present, with respect to the total mass of the molding material, at a content of preferably 90 percent by mass or less, more preferably 70 percent by mass or less, even more preferably 50 percent by mass or less, and further preferably 40 percent by mass or less. When the content of the highly polar polyester is in the range described above, even if the molding thermal history exists, a more preferable mechanical strength tends to be obtained.

### 1.2.3. OTHER RESINS

The resin contained in the molding material according to this embodiment may include at least one of other resins other than the polyester-based elastomer and the highly polar polyester. As the other resins described above, for example, there may be mentioned an olefin-based resin, such as a polyethylene or a polypropylene, an urethane-based resin, and/or an acrylic-based resin.

### 1.2.4. MOLECULAR WEIGHT DISTRIBUTION

In a molecular weight distribution curve by a GPC method, the resin contained in the molding material according to this embodiment has a maximum value 2 at a weight average molecular weight of 100,000 or more and a maximum value 1 at a weight average molecular weight less than that at the maximum value 2, and an area value in the maximum value 2 is smaller than an area value in the maximum value 1. As described above, since the resin has appropriate high molecular weight components, even when the resin is pyrolyzed by the molding thermal history, the mechanical strength can be maintained.

The GPC method is a gel permeation chromatography and may be performed, for example, by the following procedure. A GPC apparatus (ACQUITY APC, manufactured by Waters) provided with two separation columns (TSKgel SuperHZM-H, manufactured by Tosoh Corporation) connected in series is used. After a measurement sample (molding material) is dissolved in chloroform used as an eluent and then filtrated by a filter having a pore diameter of 0.45 μm, a GPC analysis is performed on a dissolved component, so that the molecular weight distribution curve of the resin is obtained. In this case, the column temperature is set to 40° C., and as a detector, an IR detector is used. In addition, as the standard sample, the polystyrenes (manufactured by Agilent) are used.

As a peak calculation method, for example, the following may be performed. A chromatogram is regarded as a linear function, and positions at which the slopes are zero by differentiation are defined as peak tops. The chromatogram is regarded as a linear function, and positions at which the slopes are zero by second order differentiation are defined as peak boundaries. The peaks are divided in a vertical direction through the peak boundary positions, and area values of the areas thus obtained are each calculated. In addition, when the peaks are sufficiently separated from each other, the area values each may be obtained as the single peak. In addition, when two peaks overlapped with each other are sufficiently identified, the peaks are regarded as a shouldered peak, and by drawing a line along the root of a smaller peak, the area values of the two peaks may be respectively calculated. Furthermore, by using peak separation software, the peak areas of the peaks each may be calculated. However, the concordance rate is set to 90% or more.

In the molecular weight distribution curve by the GPC method, although the resin contained in the molding material according to this embodiment has the maximum value 2 at a weight average molecular weight of 100,000 or more, the weight average molecular weight is preferably 110,000 or more, more preferably 120,000 or more, and further preferably 130,000 or more. In addition, the maximum value 2 is located at a weight average molecular weight of preferably 500,000 or less, more preferably 400,000 or less, and further preferably 350,000 or less. When the maximum value 2 is in the range described above, even if the molding thermal history exists, a more preferable mechanical strength tends to be obtained.

In the molecular weight distribution curve by the GPC method, although the resin contained in the molding material according to this embodiment has the maximum value 1 at a weight average molecular weight less than that at the maximum value 2, the maximum value 1 is located at a weight average molecular weight of preferably 150,000 or less, more preferably 120,000 or less, and further preferably 100,000 or less. In addition, the maximum value 1 is located at a weight average molecular weight of preferably 30,000 or more, more preferably 50,000 or more, and further preferably 60,000 or more. When the maximum value 1 is in the range described above, even if the molding thermal history exists, a more preferable mechanical strength tends to be obtained.

In addition, (weight average molecular weight at the maximum value 2)/(weight average molecular weight at the maximum value 1) is preferably more than 1.0 to 5.0, more preferably 1.1 to 4.0, even more preferably 1.2 to 3.5, further preferably 1.5 to 3.0, and particularly preferably 1.6 to 2.5. In the case described above, even if the molding thermal history exists, a more preferable mechanical strength tends to be obtained . . .

### 1.3. CROSS-LINKING AGENT

The molding material according to this embodiment may further contain a cross-linking agent. Since the cross-linking agent is contained, the molecular weight distribution of the resin is likely to be controlled, and as a result, even if the molding thermal history exists, a more preferable mechanical strength tends to be obtained.

As the cross-linking agent, a compound having a reaction group capable of cross-linking with a polyester is preferable. In more particular, the cross-linking agent preferably has a reaction group selected from the group consisting of a carbodiimide, an amine, an epoxy, an isocyanate, a protected isocyanate, a carboxylic acid anhydride, and a carboxylic acid. Since a cross-linking agent having the reaction group as described above is able to preferably react with the polyester-based elastomer and/or the highly polar polyester, the molecular weight distribution of the resin is likely to be controlled, and as a result, even if the molding thermal history exists, a more preferable mechanical strength tends to be obtained.

As the cross-linking agent, a commercial product may also be used, and for example, there may be mentioned Metabrane P-1901 (manufactured by Mitsubishi Chemical Corporation), Denacol EX-321 (manufactured by Nagase Chemtex Corporation, trimethylolpropane polyglycidyl ether), Denacol EX-211 (manufactured by Nagase ChemteX Corporation, neopentyl glycol diglycidyl ether), Duranate E402-B80B (manufactured by Asahi Kasei Corporation, isocyanate), Carbodilite HMV-5CA-LC (manufactured by Nisshibo Chemical Inc.), Carbodilite Elastostab H01 (manufactured by Nisshibo Chemical Inc.), Sigma-Aldrich: product No. 188050 (manufactured by Merck, poly (ethylene-alt-maleic anhydride).

The cross-linking agent is present, with respect to the total mass of the molding material, at a content of preferably 1 percent by mass or more and more preferably 2 percent by mass or more. In addition, the cross-linking agent is present, with respect to the total mass of the molding material, at a content of preferably 10 percent by mass or less, more preferably 8 percent by mass or less, and further preferably 6 percent by mass or less. When the content of the cross-linking agent is in the range described above, even if the molding thermal history exists, a more preferable mechanical strength tends to be obtained.

In addition, when the total content of the resin is regarded as 100 parts by mass, the content of the cross-linking agent is preferably 3 to 20 parts by mass, more preferably 5 to 15 parts by mass, and further preferably 7 to 13 parts by mass. When the content of the cross-linking agent is in the range described above, even if the molding thermal history exists, a more preferable mechanical strength tends to be obtained.

### 1.4. FLAME RETARDANT

The molding material according to this embodiment may contain a flame retardant. As the flame retardant, a known substance may be used. As the flame retardant, for example, there may be mentioned an inorganic-based flame retardant, such as an antimony compound, a metal hydroxide, a nitrogen compound, or a boron compound, or an organic-based flame retardant, such as bromine compound or a phosphorus compound.

As the flame retardant, a commercial product may also be used, and for example, Rabitle FP-110 (manufactured by Mitsui Fine Chemicals, Inc., phosphazene-based flame retardant) or Exolit Op1230 (manufactured by Clariant, phosphoric acid ester-based flame retardant) may be mentioned.

The flame retardant is present, with respect to the total mass of the molding material, at a content of preferably 1 to 15 percent by mass, more preferably 1 to 10 percent by mass, and further preferably 3 to 8 percent by mass. When the content of the flame retardant is in the range described above, while the flame retardancy of the molded product is improved, even if the molding thermal history exists, a more preferable mechanical strength tends to be obtained.

In addition, when a total content of the cellulose fibers, the polyester-based elastomer, and the highly polar polyester is regarded as 100 parts by mass, the content of the flame retardant is preferably 1 to 20 parts by mass, more preferably 5 to 20 parts by mass, and further preferably 8 to 15 parts by mass. When the content of the flame retardant is in the range described above, while the flame retardancy of the molded product is improved, even if the molding thermal history exists, a more preferable mechanical strength tends to be obtained.

### 1.5. OTHER COMPONENTS

The molding material according to this embodiment may also contain other components, such as a colorant, an insecticide, a fungicide, an antioxidant, an UV absorber, an aggregation inhibitor, and/or a mold release agent.

### 2. METHOD FOR MANUFACTURING MOLDING MATERIAL

A method for manufacturing a molding material will be described. As the method for manufacturing a molding material, a known method may be used. In particular, for example, the following methods may be used.

First, the raw materials described above are kneaded by a single screw kneader or a twin-screw kneader to form strands. Subsequently, the strands thus formed are pelletized into a molding material in the form of pellets.

In addition, as the method for manufacturing a molding material, the following method may also be used. First, waste paper and/or pulp materials are coarsely pulverized by a shredder apparatus to form cellulose fibers. Next, the cellulose fibers, the polyester-based elastomer, and the highly polar polyester are weighed and then kneaded together. Subsequently, the raw materials thus kneaded are deposited in air to form sheet-shaped deposits. Since the deposits have a low density due to a large amount of air incorporated therein, the air is removed by compression using a calendar apparatus to increase the density. Next, heating is performed in a contactless manner using a heating furnace, and a heat press operation is then performed by a heat press apparatus.

By the heating furnace and the heat press apparatus, the heating is preferably performed at a temperature higher than the melting temperatures of the polyester-based elastomer and the highly polar polyester by approximately 20° C. Accordingly, a sheet tends to be formed such that the raw materials are dispersed while being suppressed from being deviated.

Next, the sheet is cut into a desired shape by a shredder apparatus to form a molding material in the form of pellets. The desired shape of the molding material is not particularly limited, and for example, an approximately cubic shape having a side length of 2 to 5 mm may be mentioned. By the method described above, the molding material can be manufactured. In addition, the method for manufacturing a molding material is not limited to that described above.

### 3. EXAMPLES

Hereinafter, although the present disclosure will be described in more detail with reference to Examples, the present disclosure is not limited thereto.

### 3.1. MANUFACTURING OF MOLDING MATERIALS AND TEST PIECES

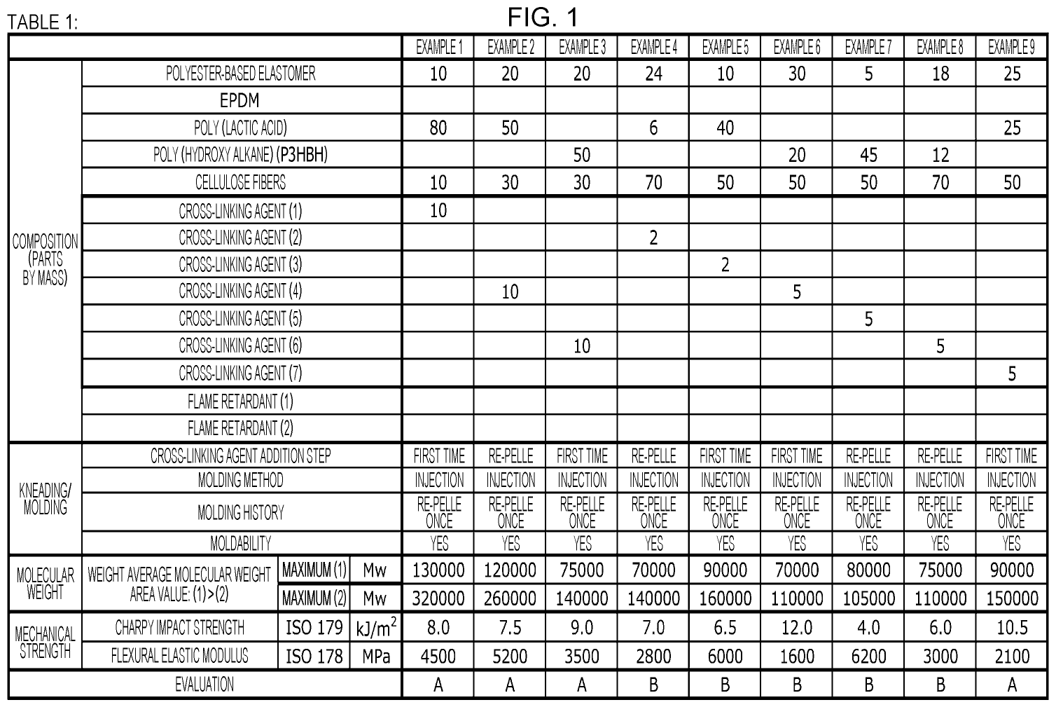

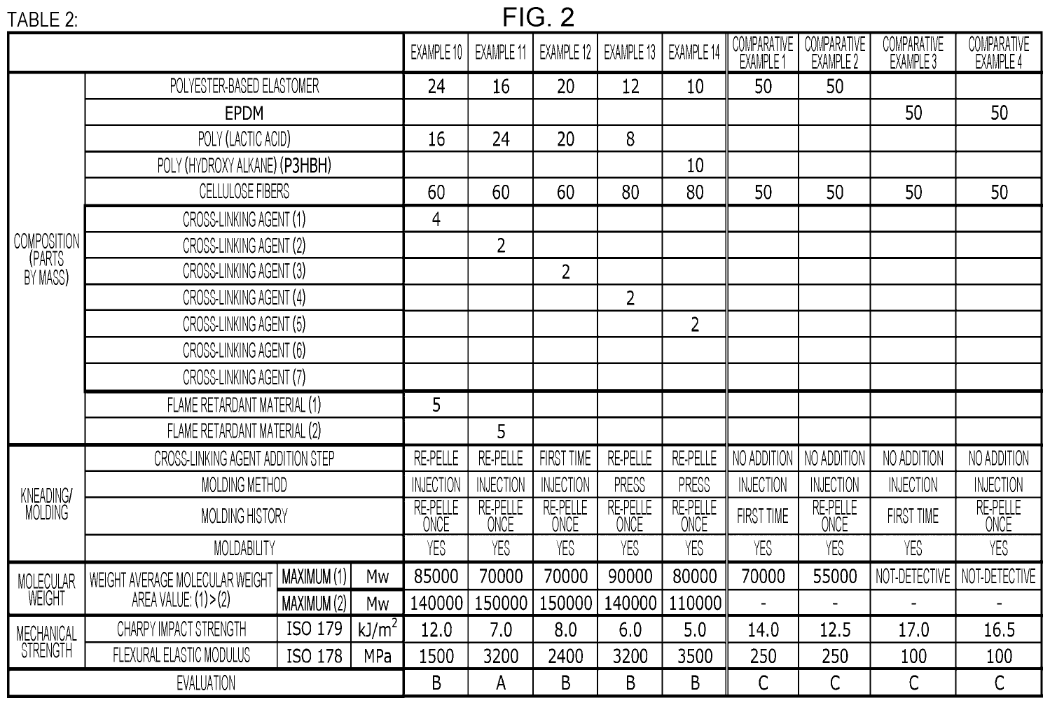

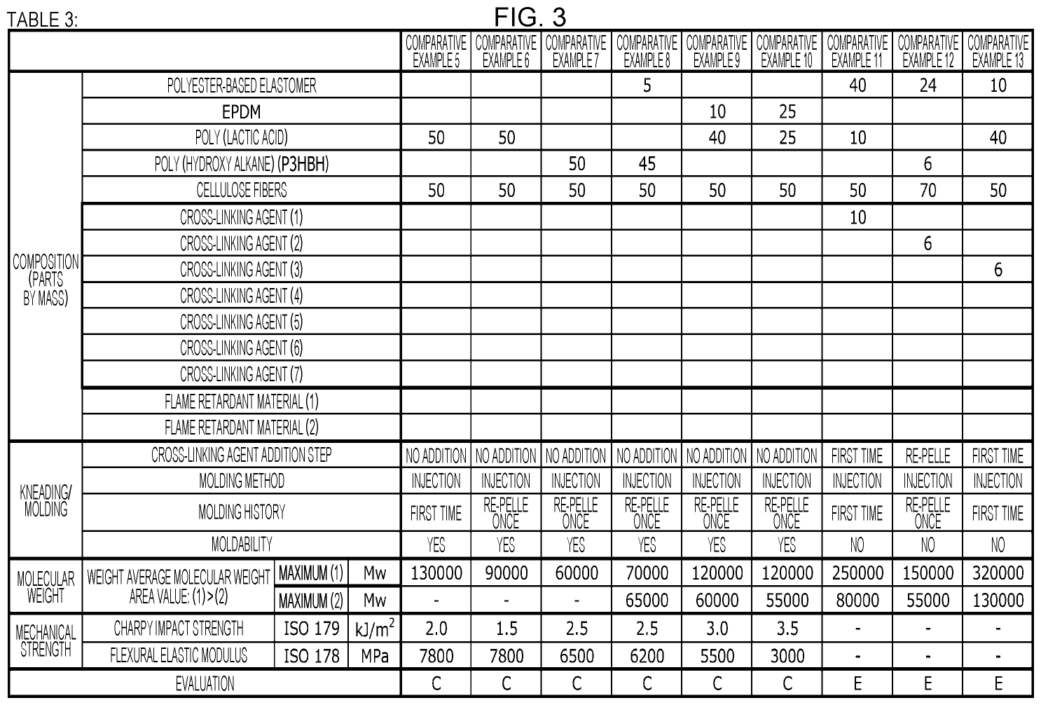

In FIGS. 1 to 3 (Tables 1 to 3), compositions of raw materials, molding methods, and evaluation results of molded products relating to the molding materials of Examples and Comparative Examples are shown. In the columns of the compositions in FIGS. 1 to 3 (Tables 1 to 3), the unit of the numeral value is part(s) by mass, and the column with no numeral value indicates that the material is not contained.

FIGS. 1 to 3 (Tables 1 to 3) will be further described.

Polyester-Based Elastomer
trade name ES-A60NX, manufactured by Aronkasei Co., Ltd. Olefin-Based Elastomer
EPDM (ethylene propylene diene rubber) (trade name NOLDEL (registered trademark) 3720P, manufactured by Dow Toray Co., Ltd.)

Highly Polar Polyester
poly (lactic acid) (trade name Terramac (registered trademark) TE-2000, manufactured by Unitika Ltd.)
poly (hydroxy alkane) (P3HBH) (trade name Green Planet (registered trademark), manufactured by Kaneka Corporation)

### Cellulose Fibers

trade name Guaiba BEKP, manufactured by CMPC

### Cross-Linking Agent”

cross-linking agent (1) (Metablen P-1901, manufactured by Mitsubishi Chemical Corporation)
cross-linking agent (2) (Denacol EX-321, manufactured by Nagase ChemteX Corporation, trimethylolpropane polyglycidyl ether)
cross-linking agent (3) (Denacol EX-211, manufactured by Nagase ChemteX Corporation, neopentyl glycol diglycidyl ether)”
cross-linking agent (4) (Duranate E402-B80B, manufactured by Asahi Kasei Corporation, isocyanate)
cross-linking agent (5) (Carbodilite HMV-5CA-LC, manufactured by Nisshibo Chemical Inc.)
cross-linking agent (6) (Carbodilite Elastostab H01, manufactured by Nisshibo Chemical Inc.)
cross-linking agent (7) (Sigma-Aldrich: product No. 188050, manufactured by Merck, poly (ethylene-alt-maleic anhydride).

### Flame Retardant

flame retardant (1) (Rabitle FP-110 (manufactured by Mitsui Fine Chemicals, Inc., phosphazene-based flame retardant)
flame retardant (2) (Exolit OP1230 (manufactured by Clariant, phosphoric acid ester-based flame retardant)

In accordance with the compositions shown in FIGS. 1 to 3 (Tables 1 to 3), the molding materials according to Examples and Comparative Examples were manufactured. In particular, the polyester-based elastomer, the highly polar polyester, the olefin-based elastomer used as the other elastomer, the cellulose fibers, the cross-linking agent, and the like were weighed.

Next, the materials described above were charged into a twin-screw kneader (KZW15TW-45 MG, manufactured by Technovel Corporation) and then kneaded together. As the kneading conditions, a maximum heating temperature and an extrusion ejection amount were set to 180° C. and 1 kg/hr, respectively. Subsequently, after the mixture thus kneaded was formed into strands, the strands were further formed into the molding material in the form of pellets by a pelletizer.

The weight average molecular weight of the molding material thus obtained was measured by a GPC method. In particular, a GPC apparatus (ACQUITY APC, manufactured by Waters) provided with two separation columns (TSKgel SuperHZM-H, manufactured by Tosoh Corporation) connected in series was used as a measurement apparatus. After a measurement sample (molding material) was dissolved in chloroform used as an eluent and then filtrated using a filter having a pore diameter of 0.45 μm, a GPC analysis was performed on a dissolved component, so that the molecular weight distribution curve of the resin was obtained. In this case, the column temperature was set to 40° C., an IR detector was used as the detector, and as the standard samples, the polystyrenes (manufactured by Agilent) were used. The peak calculation method was performed as described above.

By using the molding materials according to Examples and Comparative Examples, molding processing was performed by injection molding or press working. In particular, in both the injection molding and the press working, a heating temperature of the molding material was set to 200° C. As an injection molding machine, a THX40-5V (manufactured by Nissei Plastic Industrial Co., Ltd.) was used, and as a press working machine, a hydraulic press PHKS-40ABS (manufactured by Towa Seiki Co., Ltd.) was used.

In addition, the “re-pelle once” in the molding history shown in FIGS. 1 to 3 (Tables 1 to 3) indicates the case in which after a material already molded by the molding processing described above is again formed into pellets, by using those pellets thus formed, the molding processing is again performed in a manner similar to that described above, and the “first time” indicates the case in which the molding processing is performed only once using virgin pellets, and the pellets thus used are not again re-pelletized. In addition, the “re-pelle” in the cross-linking agent addition step shown in FIGS. 1 to 3 (Tables 1 to 3) indicates the case in which when a material already molded by the molding processing described above is again re-pelletized, the addition is performed, and the “first time” indicates the case in which only when the raw materials are kneaded together, the addition is performed. As described above, the test pieces of Examples and Comparative Examples were obtained.

### 3.2. EVALUATION TESTS

As the index of impact strength, the Charpy impact strength was used, and the measurement method was performed in accordance with ISO 179 (JIs K7111). The test piece had a rectangular shape having a long side of 80 mm+2 mm, a short side of 4.0 mm+0.2 mm, and a thickness of 10.0 mm+0.2 mm. As the test equipment, an Impact Tester IT manufactured by Toyo Seiki Seisaku-Sho Ltd. was used. In the Charpy impact test, a hammer weight, a lifting angle, a notch height, and a notch angle were set to 4 J (WR2.14 N/m), 150°, 8.0 mm+0.2 mm, and 45°, respectively.

As the index of flexural strength, flexural characteristics were used, and the test method was performed in accordance with ISO 178 (JIS K7171). The test piece had a rectangular shape having a long side of 80 mm+2 mm, a short side of 10.0 mm+0.2 mm, and a thickness of 4.0 mm+0.2 mm. As the test equipment, a 68TM-30 manufactured by Instron was used, and the test was performed at an inter-fulcrum distance of 64 mm.

Based on the test results of respective levels thus obtained, the strengths of the molded products were evaluated in accordance with the following evaluation criteria.

### Evaluation Criteria

A: Charpy impact strength is 7 KJ/m2 or more, and flexural elastic modulus is 3,000 MPa or more.

B: Charpy impact strength is 4 KJ/m2 or more, and flexural elastic modulus is 1,500 MPa or more (however, excluding the range of A evaluation).

C: Charpy impact strength is 4 KJ/m2 or more, or flexural elastic modulus is 1,500 MPa or more (however, excluding the ranges of A and B evaluations).

D: Charpy impact strength is 4 kJ/m2 or less, and flexural elastic modulus is 1,500 MPa or less (however, excluding the ranges of B and C evaluations).

E: Molding is not available.

### 3.3. EVALUATION RESULTS

The evaluation results are shown in FIGS. 1 to 3 (Tables 1 to 3).

From the results shown in FIGS. 1 to 3 (Tables 1 to 3), it was found that according to each of the molding materials of Examples, even if the molding thermal history exists, a preferable mechanical strength can be obtained. The molding materials described above each contain the cellulose fibers and the resin, and the resin includes the polyester-based elastomer and the highly polar polyester. In addition, in the molecular weight distribution curve by the GPC method, the resin has the maximum value 2 at a weight average molecular weight of 100,000 or more and the maximum value 1 at a weight average molecular weight of less than that at the maximum value 2, and the area value in the maximum value 2 is smaller than the area value in the maximum value 1.

On the other hand, according to the molding materials of Comparative Examples in each of which the structure described above is not satisfied, when the molding thermal history exists, a preferable mechanical strength cannot be obtained.

From the embodiments described above, the following conclusions are obtained.

A molding material according to the present disclosure is a molding material containing cellulose fibers and a resin, and the resin includes a polyester-based elastomer and a highly polar polyester, In the molding material described above, the resin has, in a molecular weight distribution curve by a GPC method, a maximum value 2 at a weight average molecular weight of 100,000 or more and a maximum value 1 at a weight average molecular weight less than that at the maximum value 2, and an area value in the maximum value 2 is smaller than an area value in the maximum value 1.

The molding material described above may further contain a cross-linking agent.

According to one of the molding materials described above, the cross-linking agent may have a reaction group selected from the group consisting of a carbodiimide, an amine, an epoxy, an isocyanate, a protected isocyanate, a carboxylic acid anhydride, and a carboxylic acid.

According to one of the molding materials described above, a content of the polyester-based elastomer may be 25 percent by mass or more with respect to a content of the highly polar polyester, and a total content of the polyester-based elastomer and the highly polar polyester may be equal to or less than a content of the cellulose fibers.

According to one of the molding materials described above, a content of the polyester-based elastomer with respect to a content of the highly polar polyester may be 400 percent by mass or less.

According to one of the molding materials described above, the polyester-based elastomer may include, as raw material monomers, an alkylene diol which has an alkylene group with 2 to 8 carbon atoms and one of phthalic acid and an alkylene dicarboxylic acid which has an alkylene group with 2 to 8 carbon atoms.

According to one of the molding materials described above, the polyester-based elastomer may include another raw material monomer besides the raw material monomers described above, and the another raw material may be at least one selected from the group consisting of styrene, butadiene, acrylic acid, an acrylate ester, methacrylic acid, a methacrylate ester, acetonitrile, isobutylene, isoprene, and ethylene.

According to one of the molding materials described above, the highly polar polyester may have a repeating structure derived from a raw material monomer, and in the repeating structure, the number of oxygen atoms may be one or more with respect to two carbon atoms.

According to one of the molding materials described above, the highly polar polyester may include at least one selected from the group consisting of a poly (lactic acid) and a poly (hydroxybutyric acid).

According to one of the molding materials described above, the cellulose fibers may have an average fiber length of less than 500 μm.

The present disclosure is not limited to the embodiments described above and may be variously changed and modified. For example, the present disclosure includes substantially the same structure as the structure described in the embodiment. That is, the substantially the same structure includes, for example, the structure in which the function, the method, and the result are the same as those described above or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

What is claimed is:

1. A molding material comprising:
cellulose fibers; and
a resin,
wherein the resin includes a polyester-based elastomer and a highly polar polyester,
in a molecular weight distribution curve by a GPC method, the resin has a maximum value 2 at a weight average molecular weight of 100,000 or more and a maximum value 1 at a weight average molecular weight less than that at the maximum value 2, and
an area value in the maximum value 2 is smaller than an area value in the maximum value 1.

2. The molding material according to claim 1, further comprising:
a cross-linking agent.

3. The molding material according to claim 2,
wherein the cross-linking agent has a reaction group selected from the group consisting of a carbodiimide, an amine, an epoxy, an isocyanate, a protected isocyanate, a carboxylic acid anhydride, and a carboxylic acid.

4. The molding material according to claim 1,
wherein a content of the polyester-based elastomer is 25 percent by mass or more with respect to a content of the highly polar polyester, and
a total content of the polyester-based elastomer and the highly polar polyester is equal to or less than a content of the cellulose fibers.

5. The molding material according to claim 1,
wherein a content of the polyester-based elastomer with respect to a content of the highly polar polyester is 400 percent by mass or less.

6. The molding material according to claim 1,
wherein the polyester-based elastomer includes, as raw material monomers, an alkylene diol which has an alkylene group with 2 to 8 carbon atoms and one of phthalic acid and an alkylene dicarboxylic acid which has an alkylene group with 2 to 8 carbon atoms.

7. The molding material according to claim 6,
wherein the polyester-based elastomer includes another raw material monomer besides the raw material monomers, and
the another raw material monomer is at least one selected from the group consisting of styrene, butadiene, acrylic acid, an acrylate ester, methacrylic acid, a methacrylate ester, acetonitrile, isobutylene, isoprene, and ethylene.

8. The molding material according to claim 1,
wherein the highly polar polyester has a repeating structure derived from a raw material monomer, and
in the repeating structure, the number of oxygen atoms is one or more with respect to two carbon atoms.

9. The molding material according to claim 1,
wherein the highly polar polyester includes at least one selected from the group consisting of a poly (lactic acid) and a poly (hydroxybutyric acid).

10. The molding material according to claim 1,
wherein the cellulose fibers have an average fiber length of less than 500 μm.
